(19) United States
(12) Patent Application Publication
(10) Pub. No.: US 2008/0025532 A1
(43) Pub. Date: Jan. 31, 2008

(54) MICROPHONE CASE AND CONDENSER MICROPHONE

(75) Inventors: Kentaro Yonehara, Shizuoka-shi (JP); Motoaki ITO, Shizuoka-shi (JP); Norihiro SAWAMOTO, Shizuoka-shi (JP); Yasunori TSUKUDA, Shizuoka-shi (JP)

Correspondence Address: SUGHRUE-265550, 2100 PENNSYLVANIA AVE. NW, WASHINGTON, DC, 20037-3213, US

(73) Assignee: STAR MICRONICS CO., LTD, Shizuoka-shi (JP)

(21) Appl. No.: 11/829,444

(22) Filed: Jul. 27, 2007

(30) Foreign Application Priority Data
Jul. 27, 2006 (JP) 2006-205201
Nov. 30, 2006 (JP) 2006-322998

(51) Int. Cl. H04R 25/00; H04R 9/08

(52) U.S. Cl. 381/174; 381/369

(57) ABSTRACT

A microphone case includes: a plastic basic frame including a space for housing an electro-acoustic transducing unit; a plastic substrate for closing an opening of the space, the plastic substrate being bonded to the basic frame; conductive layers provided on the bonding surfaces of the basic frame and the substrate respectively, the conductive layers being electrically connected to each other; and exposed portions where the surfaces of the basic frame and the substrate are exposed, wherein the basic frame and the substrate are bonded to each other in the exposed portions.

### CROSS REFERENCE TO RELATED APPLICATION

This application claims priority from a Japanese Patent Application No. 2006-205201 filed on Jul. 27, 2006, and a Japanese Patent Application No. 2006-322998 filed on Nov. 30, 2006, the entire subject matter of which is incorporated herein by reference.

### TECHNICAL FIELD

The present invention relates to a microphone case and a condenser microphone used for various apparatuses such as a cellular phone, a video camera, and a personal computer.

### BACKGROUND

An example of a known condenser microphone is disclosed in JP-A-2002-345092. That is, in the known microphone, a unit is constituted by laminating and fixing a circuit substrate mounted with electric components, a lower spacer, a back electrode substrate having a back electrode, an upper spacer, and a vibrating membrane supporting frame in which a vibrating membrane is tightly provided sequentially from a bottom part and the unit is housed in a metal case.

### SUMMARY

However, in this kind of condenser microphone, an adhesive agent is interposed between bonding surfaces of the members at the time of laminating and fixing the above-mentioned circuit substrate and the back electrode substrate. In this case, it is necessary to electrically connect conductive patterns provided on the members between the bonding surfaces of the members so as to ensure earth connection. As a result, an adhesive agent layer between the conductive patterns is formed thinner or a conductive adhesive agent containing a conductive binder is used so as not to inhibit conduction between the conductive patterns.

However, when the adhesive agent layer is very thinner, high bonding strength is not ensured and intensity of the microphone is lowered. When the conductive adhesive agent containing the conductive binder is used, a manufacturing cost is increased due to a high price of the adhesive agent and a gas is generated from the binder due to a heat generated in reflowing, and leakage of electric charges occurs on an electret layer such as the back electrode substrate due to the gas, whereby performance of a condenser microphone is remarkedly lowered.

In a lamination-structure condenser microphone constituted mainly of three-layer substrates (a circuit substrate, a case substrate, and a top substrate), when the circuit substrate and the top substrate are bonded onto both upper and lower surfaces of the case substrate, respectively, bonding performance of the adhesive agent to the metallic layers is by far inferior to bonding performance of the adhesive agent to a core material (e.g. a glass epoxy resin plate) of the substrate. The reason is as follows. Since a surface of the metallic layer has smoothness better than the core material of the substrate, bonding strength of the adhesive agent decreases.

Assuming that the heat is applied to the condenser microphone in the same manner as in reflowing at the time of mounting the condenser microphone on the substrate, the core material of a case substrate (e.g. the glass epoxy resin plate) has a coefficient of thermal expansion higher than a metallic layer (e.g. a copper foil), whereby the core material pushes up the metallic layer. In this case, a force is applied to the metallic layer on front and back surfaces of the case substrate which is in communication with a through-hole (a via-hole) in a direction away from the core material by an internal expansion pressure of the core material at the time of applying the heat. As a result, assuming that strength of the through-hole is not enough, the metallic layers on the front and back surfaces are cracked, whereby the metallic layers will not be conducted.

The invention is made in view of the problems of related art. An object of the invention is to make it possible to acquire a high-strength case of the condenser microphone, to manufacture the high-strength case of the condenser microphone at low cost, and to achieve a high-performance condenser microphone.

An object of the invention is to provide the condenser microphone and a method of manufacturing the condenser microphone in which the bonding performance between the core material of the case substrate and the circuit substrate and between the core material of the case substrate and the top substrate can be improved at the time of bonding the circuit substrate and the top substrate to the front and back surfaces of the case substrate.

In order to accomplish the above-mentioned object, according to a first aspect of the invention, there is provided a microphone case including: a plastic basic frame including a space for housing an electro-acoustic transducing unit; a plastic substrate for closing an opening of the space, the plastic substrate being bonded to the basic frame; conductive layers provided on the bonding surfaces of the basic frame and the substrate respectively, the conductive layers being electrically connected to each other; and exposed portions where the resin surfaces of the basic frame and the substrate are exposed, the exposed portions being provided on the bonding surfaces, wherein the basic frame and the substrate are bonded to each other in the exposed portions.

Accordingly, the basic frame and the substrate are bonded and fixed to each other in the exposed portion having no conductive pattern and are electrically connected to each other by bonding between the conductive patterns. A plurality of substrates constituting the case is strongly bonded to each other and laminated and fixed to each other with the substrates conducted to each other. It is not necessary to use the conductive adhesive agent containing the conductive binder and it is possible to perform bonding with a general adhesive agent, thereby reducing a manufacturing cost. Since it is not necessary to use the conductive adhesive agent, it is possible to prevent a gas from being generated from the conductive binder and to avoid leakage of electric charges occurring due to the gas, thereby achieving a high-performance microphone.

According to a second aspect of the invention, in the microphone case according to the first aspect, the basic frame and the substrate are made of similar materials, and the basic frame and the substrate are bonded to each other with a bonding member made of the similar materials.

Accordingly, it is possible to bond and fix the basic frame and the substrate strongly and to prevent occurrence of a difference in an expansion coefficient between the basic frame and the substrate in an expansion coefficient, whereby it is possible to avoid bonding separation.

According to a third aspect of the invention, in the microphone case according to the second aspect, the bonding member is a heat-resistant bonding sheet.

The heat-resistant bonding sheet is easy to handle and contributes to promotion of efficiency in a manufacturing process, and since a gas yield is small even though the heat-resistant bonding sheet is subjected to the heat in reflowing, the heat-resistant sheet is effective to prevent the electric charges from being leaked.

According to a fourth aspect of the invention, in the microphone case according to the second aspect, the bonding member is a curable contractile bonding member.

Accordingly, the basic frame and the substrate are pulled up by curing contraction of the adhesive agent, whereby it is possible to improve bonding strength and to acquire excellent electric conduction between the conductive patterns.

According to a fifth aspect of the invention, in the microphone case according to the third aspect, the plastic substrate includes: a first substrate, which is mounted with an electric component and closes one end of the opening of the basic frame; and a second substrate, which includes a sound hole and closes the other end of the opening of the basic frame.

The microphone case is suitable for a condenser microphone having a condenser section built therein.

According to a sixth aspect of the invention, in the microphone case according to the fifth aspect, the electric component is fixed to the substrate by a fluxless fixing method.

Accordingly, production of the gas from a flux is avoided in advance and leakage of electric charges on an electret layer is prevented, whereby it is possible to achieve a high-performance microphone.

According to a seventh aspect of the invention, there is provided a condenser microphone including: a case substrate including a metallic layer; bonding areas provided on front and back surfaces of the case substrate; a top substrate; and a circuit substrate mounted with electric components, wherein the top substrate and the circuit substrate are bonded and fixed to the bonding areas respectively without using the metallic layer with an adhesive agent.

According to the seventh aspect of the invention, no metallic layer is provided in the bonding area at the time of bonding the circuit substrate and the top substrate to the front and back surfaces of the case substrate, respectively. As a result, bonding performance between a core material of the case substrate and the circuit substrate and bonding performance between a core material of the case substrate and the top substrate are improved.

Accordingly, it is possible to a condenser microphone having the above-mentioned advantages.

As described above, according to an aspect of the invention, a plurality of substrates can be strongly bonded to each other and laminated and fixed to each other with the substrates conducted to each other and leakage of electric charges can be prevented, whereby it is possible to achieve a high-performance microphone.

### BRIEF DESCRIPTION OF THE DRAWINGS

In the accompanying drawings:

FIG. 1 is a cross-sectional view illustrating a condenser microphone according to a first embodiment;

FIG. 2 is an exploded perspective view of a condenser microphone of FIG. 1;

FIG. 3 is a partial cross-sectional view enlarging a part of FIG. 1;

FIG. 4 is a plan view illustrating a bonding structure of a case basic frame to a circuit substrate;

FIG. 5 is a bottom view illustrating a bonding structure of a case basic frame to a top substrate;

FIG. 6 is a bottom view illustrating a bonding structure of a vibrating membrane and a spacer to a top substrate;

FIG. 7 is a partial plan view illustrating a manufacturing process of a condenser microphone;

FIG. 8 is a partial plan view illustrating a manufacturing process following that of FIG. 7;

FIG. 9 is a partial plan view illustrating a manufacturing process following that of FIG. 8;

FIG. 10 is a partial plan view illustrating a manufacturing process following that of FIG. 9;

FIG. 11 is a partial plan view illustrating a manufacturing process following that of FIG. 10;

FIG. 12 is a partial plan view illustrating a manufacturing process following that of FIG. 11;

FIG. 13 is a cross-sectional view illustrating a condenser microphone according to a second embodiment;

FIG. 14 is an exploded perspective view of a condenser microphone of FIG. 13;

FIG. 15 is a cross-sectional view illustrating a condenser microphone according to a third embodiment;

FIG. 16 is an exploded perspective view of a condenser microphone of FIG. 15;

FIG. 17 is an explanary view illustrating a positional relation between a conductive pattern and a resist on a front surface of a circuit substrate 123;

FIG. 18A is a plan view of a conductive pattern on a front surface of a circuit substrate 123; FIG. 18B is a plan view of a conductive pattern; FIG. 18C is a plan view of a conductive pattern on a back surface of the circuit substrate 123; and

FIG. 19 is a plan view of a case basic frame 124.

### DETAILED DESCRIPTION

### First Embodiment

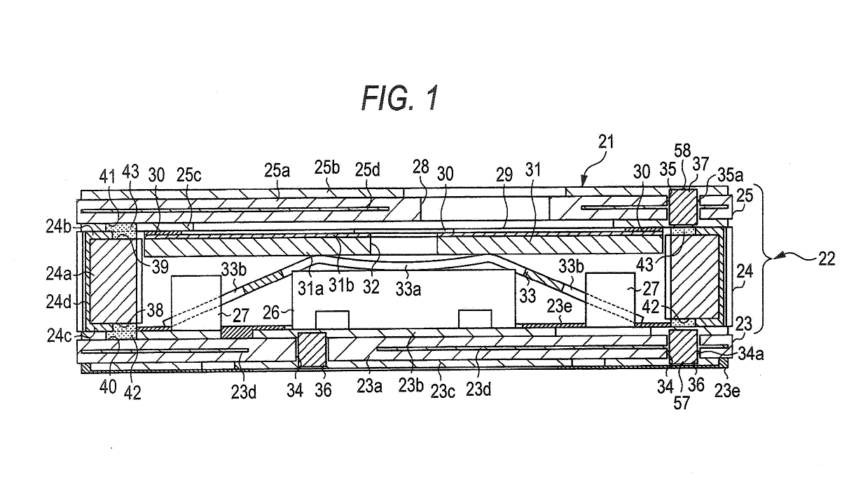

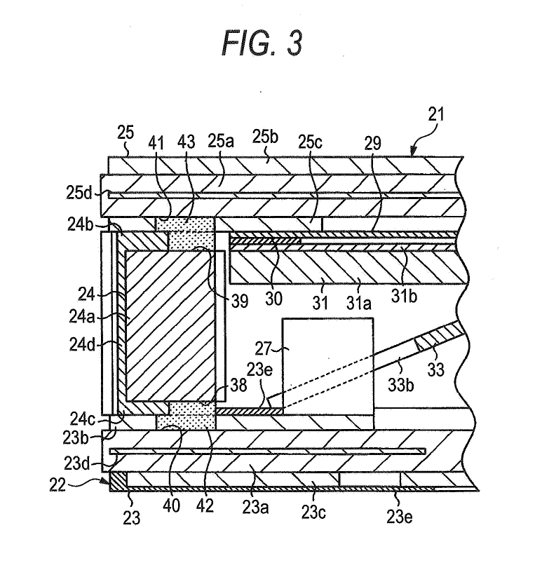

Hereinafter, embodiments of the present invention are described with reference to FIGS. 1 to 3.

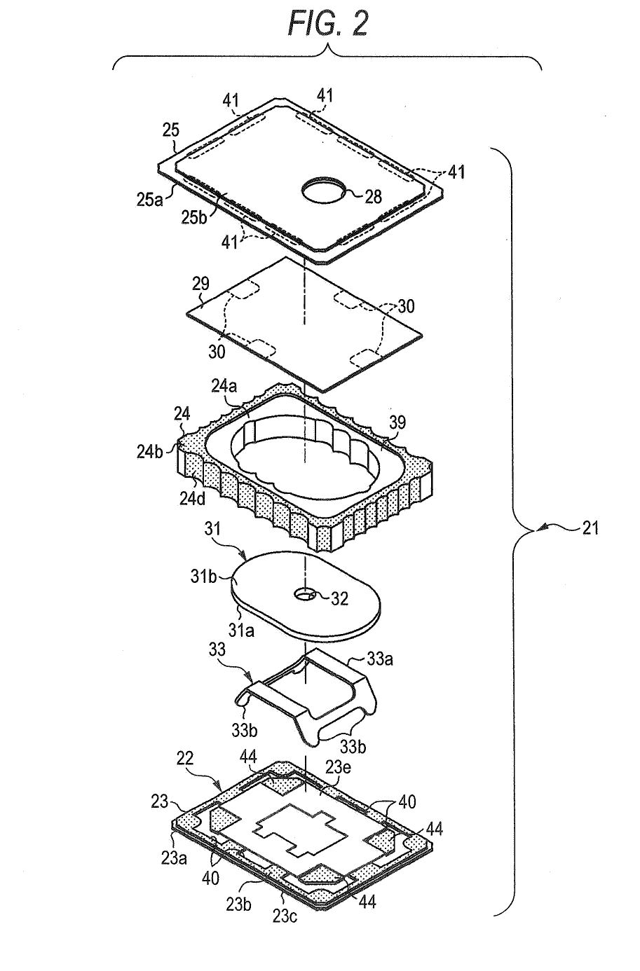

As shown in FIGS. 1 and 2, a case 22 of a condenser microphone 21 according to the embodiments has a structure in which a tabular circuit substrate 23, a wholly rectangular case basic frame 24 in which a space is formed, and a tabular top substrate 25 are laminated and fixed with an adhesive agent. The circuit substrate 23, the case basic frame 24, and the top substrate 25 are made of electric insulating materials such as an epoxy resin, liquid crystal polymer, and ceramic. In the embodiments, the circuit substrate 23, the case basic frame 24, and the top substrate 25 are made of a glass epoxy resin in which a glass fiber is incorporated into the epoxy resin.

Conductive patterns 23b and 23c are printed on both upper and lower surfaces of the circuit substrate 23 as a conductive layer made of copper. Electric components such as a field-effect transistor 26 and a capacitance 27 constituting an impedance converting circuit provided in the case 22 are mounted on the circuit substrate 23. The conductive patterns 24b and 24c as conductive layers which are arranged in series and made of copper are printed on both upper and lower surfaces and lateral surfaces of the case basic frame 24. The electric components such as the electric-filed transistor 26 and the capacitance 27 mounted on the circuit substrate 23 is housed in the space of the case basic frame 24. An insulating film 23e is printed in a predetermined position on both upper and lower surfaces of the circuit substrate 23. Conductive patterns 25b and 25c as conductive layers made of a copper foil are printed on both upper and lower surfaces and lateral surfaces of the top substrate 25. A sound hole 28 for taking in sound from an outside is formed in the top substrate 25. The conductive layers 23d and 25d which are made of the copper foil are buried in the circuit substrate 23 and the top substrate 25. The conductive layers 23d and 25d are laminated between a pair of resin sheets constituting the circuit substrate 23 and the top substrate 25.

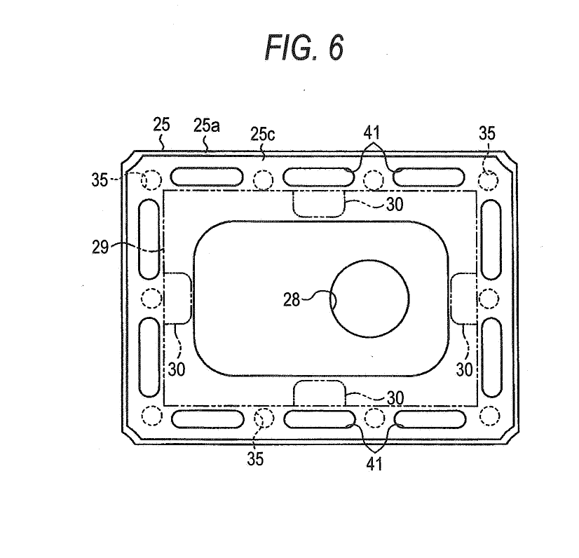

As shown in FIGS. 1 to 3 and 6, a vibrating membrane 29 made of a thin-film sheet material of PPS (polyphenylene sulfide) is tightly bonded onto a lower surface of the lower conductive pattern 25c in the top substrate 25 in the case basic frame 24 and a conductive layer not shown is formed on an upper surface of the vibrating membrane 29 by gold deposition. Chip-shaped spacers 30 made of a synthetic resin such as PPS of the similar as the material of the vibrating membrane 29 are bonded and fixed to four locations of a lower periphery of the vibrating membrane 29. In the case basic frame 24, a back plate 31 is disposed opposite to the lower surface of the vibrating membrane 29 with the spacers 30 interposed therebetween. In the back plate 31, a film 31b such as PTFE (polytetrafluorethylene) is bonded onto an upper surface of a substrate 31a formed of a stainless steel plate. A polarization treatment is performed on the film 31b by a corona discharge and the film 31b constitutes an electret layer by the polarization treatment. Accordingly, since the back plate 31 constitutes a back electrode, the condenser microphone of the embodiment is a back electret type. The back plate 31 is formed in a substantially elliptic shape in a plan view, which has an outer peripheral shape smaller than an inner peripheral shape of the case basic frame 24. A clearance is formed between the inner and outer peripheral surfaces. A through-hole 32 for allowing air transfer by vibration of the vibrating membrane 29 is formed in a central part of the back plate 31.

As shown in FIGS. 1 to 3, in the case basic frame 24, a holding member 33 formed of a plate spring material is interposed between the back plate 31 and the circuit substrate 23 in a compression state. The back plate 31 is compressed in a direction abutting lower surfaces of the spacers 30 from an opposite side of the vibrating membrane 29 by a resilient force of the holding member 33. Accordingly, a predetermined clearance as thick as a thickness of the spacer 30 is held between the vibrating membrane 29 and the back plate 31 and a condenser section having a predetermined capacity is formed therebetween. The holding member 33 is formed by gold-plating both front and back surfaces of the stainless steel plate. The back-plate 31 is electrically connected to terminals 44 of the impedance converting circuit on the circuit substrate 23 with the holding member 33 interposed therebetween.

As shown in FIG. 1, a plurality of through-holes 34 and 35 are formed on the circuit substrate 23 and the top substrate 25, respectively. Conductive patterns 34a and 35a in series with the conductive patterns 23b and 23c and the conductive patterns 25b and 25c are provided on inner peripheral surfaces of the through-holes 34 and 35, respectively. The through-holes 34 and 35 are filled with conductive materials 36 and 37. Conductive sections 57 and 58 are formed of the conductive materials 36 and 37 and the conductive patterns 34a and 35a. A conductive path is formed to an earth terminal not shown from the conductive section 58 including the conductive patterns 25b and 25c and the through-hole 35 of the top substrate 25 via the conductive patterns 24b to 24d on the case basic frame 24 and the conductive section 57 including the conductive patterns 23b and 23c and the through-hole 34 of the circuit substrate 23.

Next, the circuit substrate 23, the case basic frame 24 and the top substrate 25 constituting the case 22, and a laminated and fixed structure thereof will be described in detail.

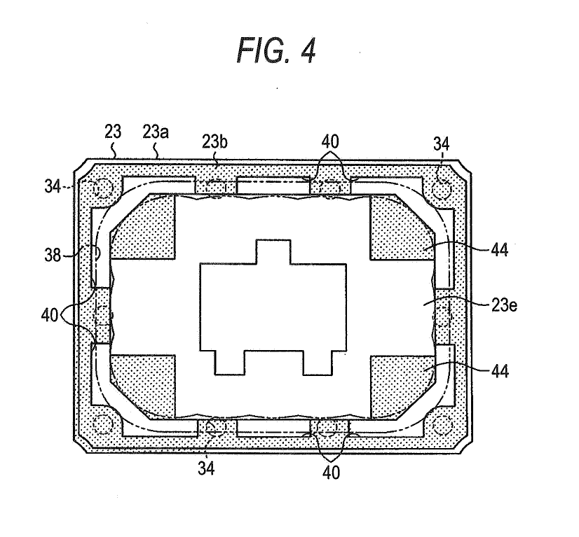

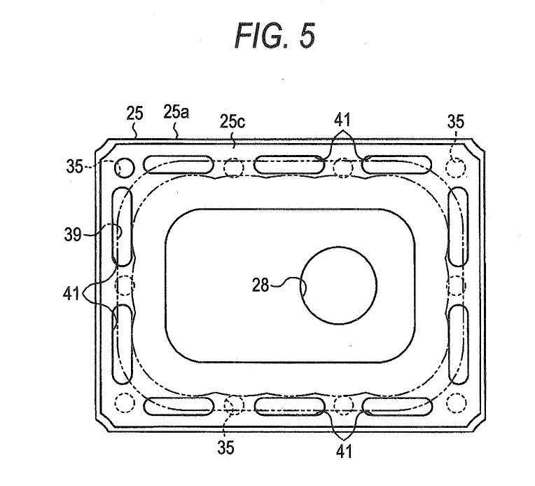

As shown in FIGS. 1 to 5, exposed portions 38 and 39 of a basic frame body 24a in which the conductive patterns 24c and 24b are not provided are formed as a whole being a perimeter shape in inner peripheries of a lower surface and an upper surface of the case basic frame 24. A plurality of exposed portions 40 of a substrate body 23a in which the conductive pattern 23b is not provided is arranged on an upper surface of the circuit substrate 23 along a perimeter-shaped zone in correspondence with a lower exposed portion 38 of the case basic frame 24. A plurality of exposed portions 41 of a substrate body 25a in which the conductive pattern 25c is not provided is arranged on a lower surface of the top substrate 25 along the perimeter-shaped zone in correspondence with an upper exposed portion 39 of the case basic frame 24.

An adhesive agent 42 made of an epoxy resin as a bonding member is interposed between the exposed portions 40 of the circuit substrate 23 and the lower exposed portion 38 of the case basic frame 24. The circuit substrate 23 and the case basic frame 24 are bonded and fixed to each other with the adhesive agent 42 in the exposed portions 40 and 38 of the substrate body 23a and the basic frame body 24a, which are made of electric insulating materials. In sections other than the exposed portions 40 and 38, the conductive pattern 23b on the upper surface of the circuit substrate 23 and the conductive pattern 24c on the lower surface of the case basic frame 24 are directly bonded with each other and the circuit substrate 23 and the case basic frame 24 are electrically connected to each other.

Similarly, an adhesive agent 43 made of the epoxy resin as the bonding member is interposed between the exposed portions 41 of the top substrate 25 and the upper exposed portion 39 of the case basic frame 24. The top substrate 25 and the case basic frame 24 are bonded and fixed to each other in the exposed portions 41 and 39 of the substrate body 25a and the basic frame body 24a with the adhesive agent 43. In sections other than the exposed portions 41 and 39, the conductive pattern 25c on the lower surface of the top substrate 25 and the conductive pattern 24b on the upper surface of the case basic frame 24 are directly bonded with each other and the top substrate 25 and the case basic frame 24 are electrically connected to each other.

A heat-resistant sheet such as a bonding sheet mainly made of epoxy and a thermoplastic resin, a sheet made of high heat-resistant acrylic adhesive agent, or a bonding sheet made of a polyolefin resin is adapted as the bonding member, i.e., the adhesive agent.

In the condenser microphone 21 of the embodiment configured as above, when a sound wave from a sound source reaches the vibrating membrane 29 through the sound hole 28 of the top substrate 25, the vibrating membrane 29 vibrates depending on a frequency, an amplitude, and a waveform of the sound. A gap between the vibrating membrane 29 and the back plate 31 is varied from a set value with vibration of the vibrating membrane 29 and thus, an impedance of the condenser is varied. The variation of the impedance is converted into a voltage signal by the impedance converting circuit.

Next, a manufacturing method of the condenser microphone 21 having the above configuration will be described.

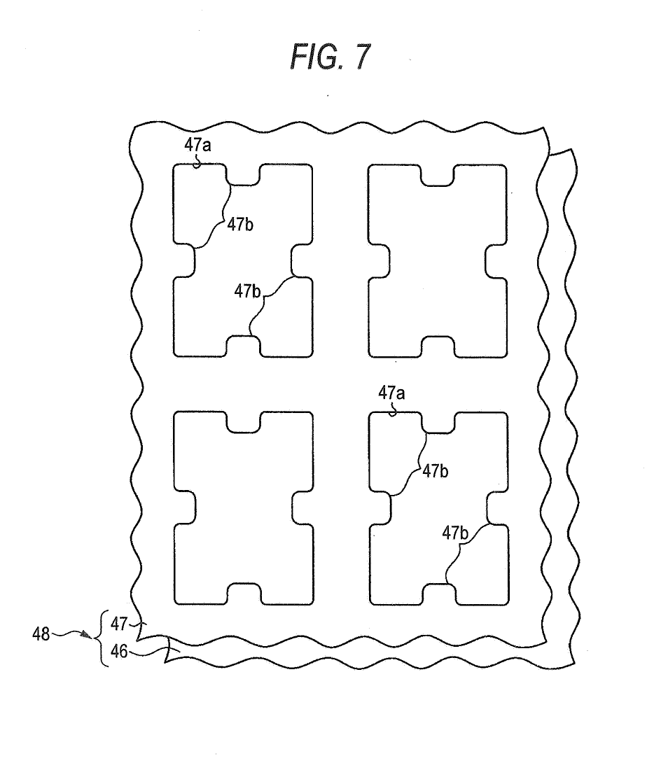

However, in manufacturing the condenser microphone 21, first, a vibrating formation sheet 46 for separately forming plural pieces of vibrating membranes 29 and a spacer formation sheet 47 for separating plural sets of spacers 30 formed of one set of four spacers are bonded and fixed with the adhesive agent and thus, a vibrating membrane assembly 48 is prepared, as shown in FIG. 7. A plurality of through-holes 47a is arranged in the spacer formation sheet 47 and convex portions 47b for separately forming the four spacers 30 are provided in inner peripheries of the through-holes 47a. The vibrating formation sheet 46 is tightly provided in each of the through-holes 47a of the spacer formation sheet 47 in a properly tight state with the both sheets 46 and 47 bonded to each other.

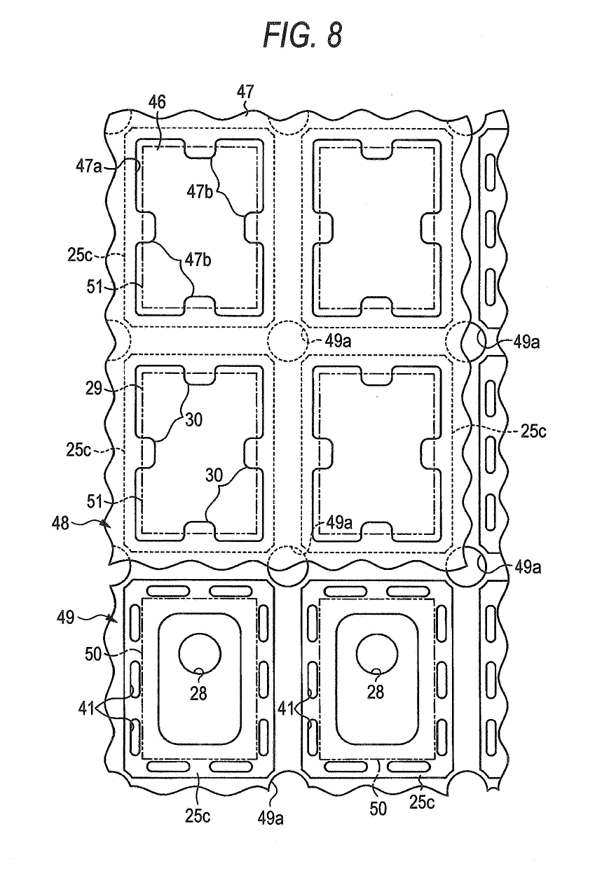

Next, as shown in FIG. 8, the vibrating membrane assembly 48 is bonded with the adhesive agent on a lower surface of a top substrate formation member 49 for separately forming plural pieces of top substrates 25. In this case, the conductive patterns 25b and 25c and the sound hole 28 for separately forming the plurality of top substrates 25 are formed in the top substrate formation member 49 at predetermined intervals. The only conductive pattern 25c on the lower surface is shown in FIG. 8. Circular-shaped through-holes 49a for fixing four corners of each of the top substrates 25 are formed in the top substrate formation member 49 in correspondence with four corners of each of the conductive patterns 25c. As shown by a two-dot chain line in a lower part of FIG. 8, the adhesive agent is applied only to a predetermined bonding area 50 on the conductive pattern 25c inside of the exposed portion 41 of each of the conductive patterns 25c of the top substrate formation member 49, whereby the vibrating membrane formation sheet 46 and the conductive pattern 25c are bonded to each other only in the bonding area 50.

Subsequently, as shown by a two-dot chain line in an upper part of FIG. 8, the vibrating membrane assembly 48 is fixed to each of the through-holes 47a of the spacer formation sheet 47 and a the plurality of vibrating membranes 29 having a size in which the vibrating membranes 29 can be housed in the case basic frame 24 and four chip-shaped spacers 30 which are bonded to the vibrating membranes 29 are formed by punching and cutting the vibrating membrane assembly 48 along a virtual cutting line 51 matching with the bonding area 50 with a laser beam. In this case, since the virtual cutting line 51 is set to be positioned in correspondence with each of the conductive patterns 25c made of metallic materials on the top substrate formation member 49, there is no possibility for damaging the top substrate formation member 49 even though punching and cutting the vibrating membrane assembly 48 with the laser.

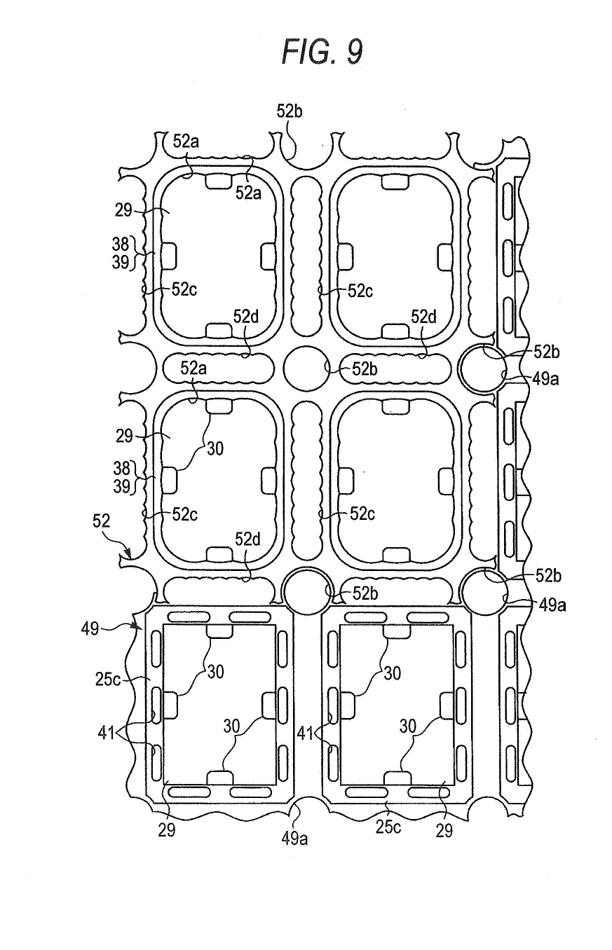

Subsequently, as shown in FIG. 9, the top substrate formation member 49 to which the vibrating membranes 29 are bonded is laminated on a case basic frame formation member 52 for separately forming a plurality of case basic frames 24 and the top substrate formation member 49 and the case basic frame formation member 52 are bonded and fixed to each other as described below. In this case, a plurality of through-holes 52a serving as an internal surface of the case basic frame 24 are formed in the case basic frame formation member 52 at predetermined intervals. Circular-shaped through-holes 52b for settling four corners of each of the case basic frames 24 and long hole-shaped through grooves 52c and 52d for settling an external surface of each of the case basic frames 24 which are formed slightly away from the through-hole 52b are formed in the case basic frame formation member 52. The conductive patterns 24b to 24d of the case basic frame 24 are formed on both front and back surfaces of the case basic frame formation member 52, inner peripheral surfaces of the through-holes 52b, and inner peripheral surfaces of the through-holes 52c and 52d.

An epoxy adhesive agent made of the similar material as the top substrate formation member 49 and the case basic frame formation member 52 is applied to any one of the exposed portion 41 in each of the conductive patterns 25c in the top substrate formation member 49 and the exposed portion 39 in an upper peripheral edge of each of the through-holes 52a in the case basic frame formation member 52, whereby the top substrate formation member 49 and the case basic frame formation member 52 are incorporated with each other and strongly bonded and to each other in the exposed portions 41 and 39 of the substrate body 25a and the basic frame body 24a. In this case, since the adhesive agent is not interposed between the conductive patterns 25c and 24b of the top substrate formation member 49 and the case basic frame formation member 52, the conductive patterns 25c and 24b thereof are directly bonded with each other and electrically conducted.

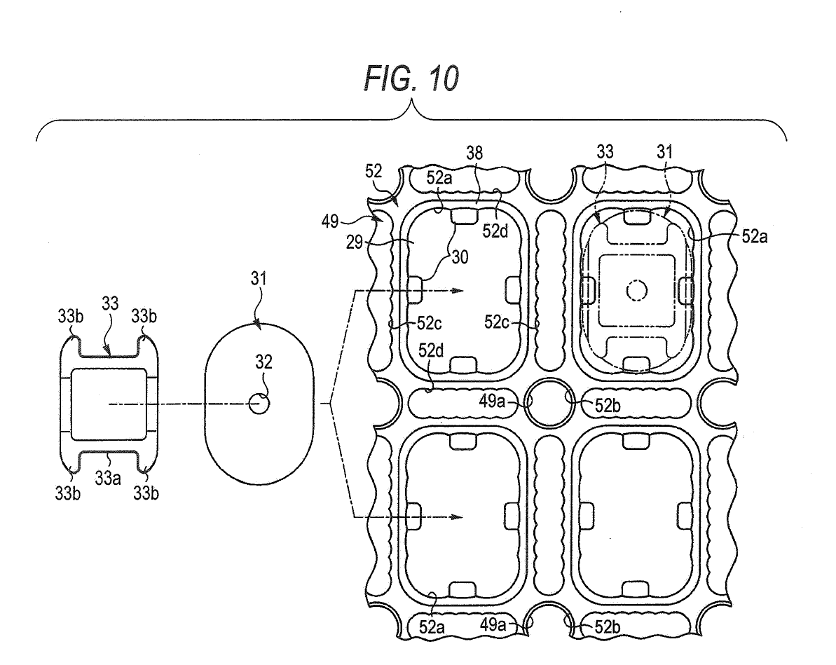

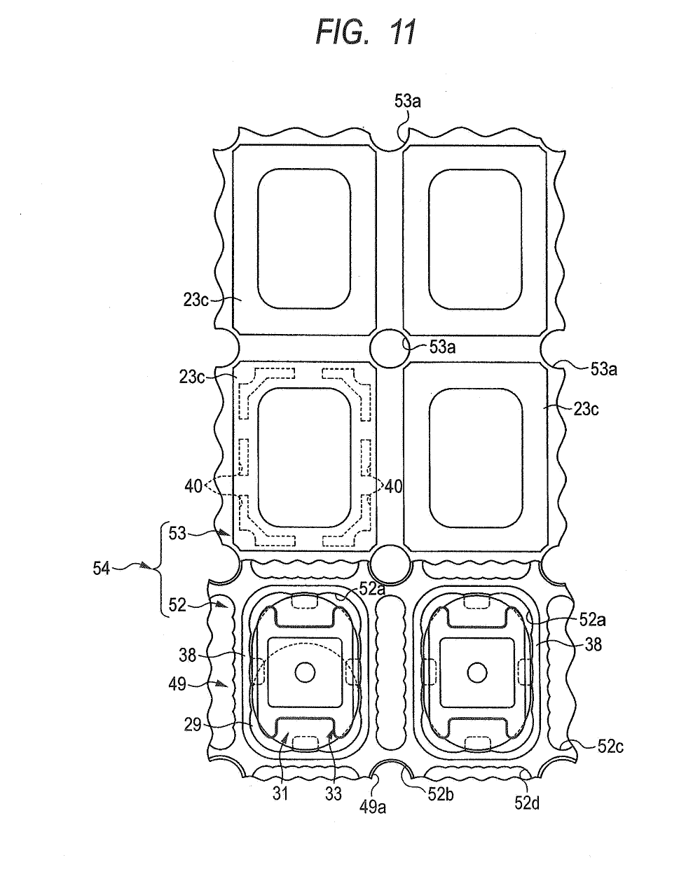

As shown in FIG. 10, the back plate 31 and the holding member 33 are put in each of the through-holes 52a of the case basic frame formation member 52 and inserted and attached. Subsequently, as shown in FIG. 11, a circuit substrate formation member 53 for forming the plurality of circuit substrates 23 in the case basic frame formation member 52 is laminated and bonded and fixed as described below, thereby forming a microphone assembly 54. In this case, the conductive patterns 23b and 23c, and the insulating film 23e for the circuit substrate 23 are formed in the circuit substrate formation member 53 and the electric components such as the field-effect transistor 26 and the capacitance 27 are loaded on the conductive pattern 23b by using laser welding precedently. The laser welding is performed by radiating the laser beam to a boundary between the electric components and the conductive patterns 23b and 23c. FIG. 11 illustrates only a part of the conductive pattern 23c on a lower surface. Circular-shaped through-holes 53a for settling four corners of each of the circuit substrates 23 are formed in the circuit substrate formation member 53 in correspondence with four corners of each of the conductive patterns 23c. Arc welding, fluxless soldering, or flux washing soldering may be used instead of the laser welding.

An epoxy adhesive agent made of the similar material as the case basic frame formation member 52 and the circuit substrate formation member 53 is applied to any one of the exposed portion 38 in a lower peripheral edge of each of the through-holes 52a in the case basic frame formation member 52 and the exposed portion 40 on each of the conductive patterns 23b in the circuit substrate formation member 53, whereby the case basic frame formation member 52 and the circuit substrate formation member 53 are incorporated with each other and strongly bonded and fixed to each other in the exposed portions 38 and 40 of the basic frame bodies 24a and 23a. In this case, since the adhesive agent is not interposed between the conductive patterns 24c and 23b of the case basic frame formation member 52 and the circuit substrate formation member 53, the conductive patterns 24c and 23b are electrically bonded with each other and thus, it is possible to obtain excellent electric conduction.

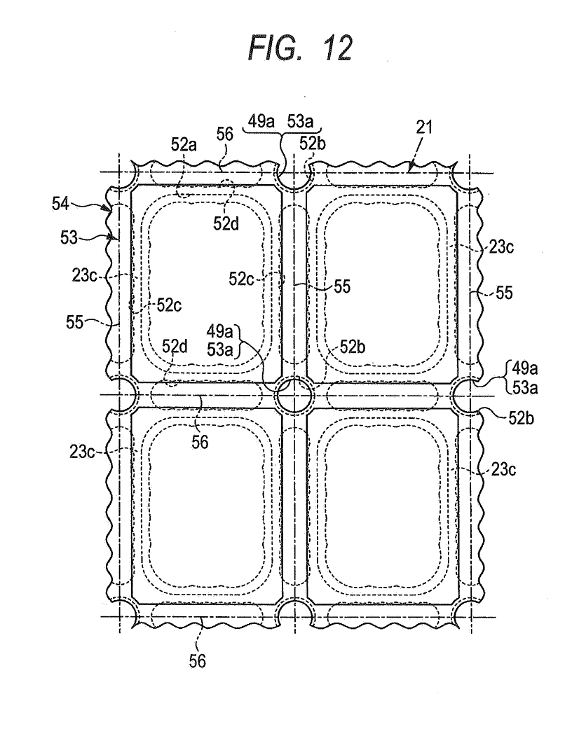

Thereafter, as shown in FIG. 12, the microphone assembly 54 are cut and separated along virtual crisscross cutting lines 55 and 56 passing through the through-holes 49a, 52b, and 53a, and the through grooves 52c and 52d by a dicing saw and a plurality of condenser microphones 21 is formed at the same time. Here, each of the cutting lines 55 and 56 is positioned on a straight line linking centers of the through-hole 49a of the top substrate formation member 49, the through-hole 52b and the through grooves 52c and 52d of the case basic frame formation member 52, and the through-hole 53a of the circuit substrate formation member 53. As a result, a cut resistance can be reduced and thus, a cutting work can be performed at low load. Even though a burr is produced on four corners of the condenser microphone 21 at the time of cutting and separating the plurality of condenser microphones 21 from the microphone assembly 54, the burr is positioned in the through-holes 49a, 52b, and 53a of the four corners of each of the condenser microphones 21, whereby it is possible to prevent the burr from protruding from external surfaces on sides of the condenser microphone 21. Even when the adhesive agent 42 and an adhesive agent 43 are spilled, the adhesive agents 42 and 43 may be overspilled into the through-holes 49a, 52b and 53a, whereby it is possible to maintain constant thickness accuracy of case 22.

The condenser microphone 21 of the embodiment configured as above has the following advantages.

The exposed portions 38 to 41 exposing a resin surface which does not include the conductive patterns 23b, 24b, 24c, and 25c are provided on parts of bonding surfaces of a plurality of substrates 23 and 25, and the basic frame 24 constituting the case 22 laminatedly. The substrates 23 and 25 opposed to each other and the basic frame 24 are bonded and fixed in the exposed portions 38 to 41. As a result, a thin bonding layer is provided between smooth metal planes such as conductive patterns and thus, it is possible to obtain a bonding strength stronger than that of a known configuration in which the members such as the basic frame and the substrate are bonded and fixed.

The conductive patterns 23b, 24b, 24c, and 25c are directly bonded with each other in sections other than the exposed portions 38 to 41 on the bonding surfaces of the substrates 23 and 25 and the basic frame 24, it is possible to ensure excellent electric conduction between each of the substrates 23 and 25 and the basic frame 24. It is not necessary to use a high-priced conductive adhesive agent containing a conductive binder and it is possible to perform bonding with a general adhesive agent, whereby a manufacturing cost may be reduced.

Since the adhesive agent which does not include the conductive binder is used and the electric components are fixed by the laser welding, the arc welding, the fluxless soldering, or flux washing soldering, it is possible to prevent a gas from being produced from the conductive binder or flux of the soldering in reflowing. As a result, it is possible to prevent the leakage of the electric charge on the electret layer in advance, thereby obtaining the high-performance condenser microphone.

Since the epoxy resin made of the similar material as the substrates 23 and 25 and the basic frame 24 is used as the adhesive agent for bonding the substrates 23 and 25 and the basic frame 24, it is possible to increase the bonding strength between the substrates 23 and 25 and the basic frame 24 and expansion coefficients between the substrates 23 and 25 and the basic frame 24 and the adhesive agent are substantially the same, whereby it is possible to prevent peeling of a bonding portion, which is caused by a difference in the expansion coefficient.

Since an epoxy resin as a curing contractive adhesive agent, which has a high curing contraction rate, is used as the adhesive agent, the same adhesive agent is remarkedly contracted with curing. As the result, the substrates 23 and 25 and the basic frame 24 are pulled up each other, whereby a strength of the condenser microphone 21 is improved and contact pressures of the conductive patterns 23b, 24b, 24c, and 25c increase, thereby ensuring the electric conduction more surely and improving a hermetic property of the case 22.

Since the entire case 22 is formed of three layers and the spacer is not interposed therebetween unlike the known configuration, it is possible to contribute a decrease in size of the microphone and since the spacer is separated into four chips, the case 22 has little to thermal deformation. Accordingly, it is possible to prevent the vibrating membrane from being excessively tight or loose by deformation of the spacer, thereby obtaining an excellent sensitivity of the microphone.

The substrate bodies 23a and 25a of the substrate 23 and the top substrate 25 are made of the electric insulating material such as the epoxy resin and have a multilayer structure in which the conductive layers 23d and 25d made of the copper foil are buried substantially in a center portion in a thickness direction. As the result, it is possible to improve a mechanical strength of the entire case 22 by improving strengths of the circuit substrate 23 and the top substrate 25 and it is possible to improve reliability of the microphone by improving electromagnetic shield property of the case 22.

In a method of manufacturing the condenser microphone 21, it is possible to discharge the adhesive agent spilled between the bonding surfaces to the through-holes 49a, 52b, and 53a and the through grooves 52c and 52d. As the result, it is possible to prevent the adhesive agent from flowing into the case 22, thereby preventing an inconvenience such as variation of an electrostatic capacitance.

Since the through-holes 49a, 52b, and 53a are positioned on four corners of each of the condenser microphones 21, whereby it is possible to prevent the burr occurring at the time of cutting and separating the condenser microphone 21 from protruding to external surfaces of the sides, it is possible to prevent a trouble from occurring in handling of the condenser microphone 21 at the time of the condenser microphone 21 on a substrate of a cellular phone.

The heat-resistant bonding sheet formed of a bonding sheet mainly made of the epoxy resin and the thermoplastic resin is adapted as the adhesive agent for bonding between the exposed portions 40 of the circuit substrate 23 and the lower exposed portion 38 of the case basic frame 24 and between the exposed portions 41 of the top substrate 25 and the upper exposed portion 39 of the case basic frame 24. Since the heat-resistant sheet is easy to handle and a gas production amount is small by a heat in reflowing, it is possible to effectively prevent the leakage of the electric charge.

### Second Embodiment

Next, a second embodiment according to the invention will be described focusing on parts other than the parts of the first embodiment.

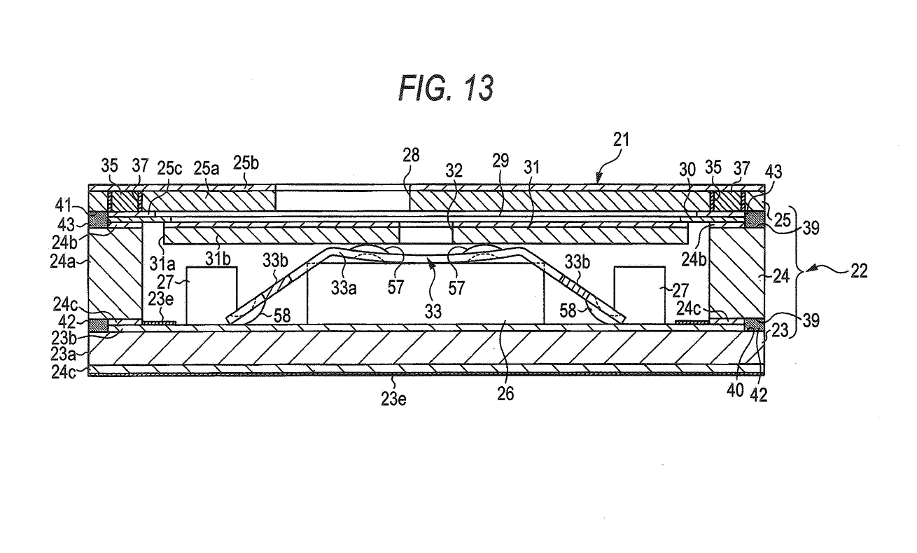

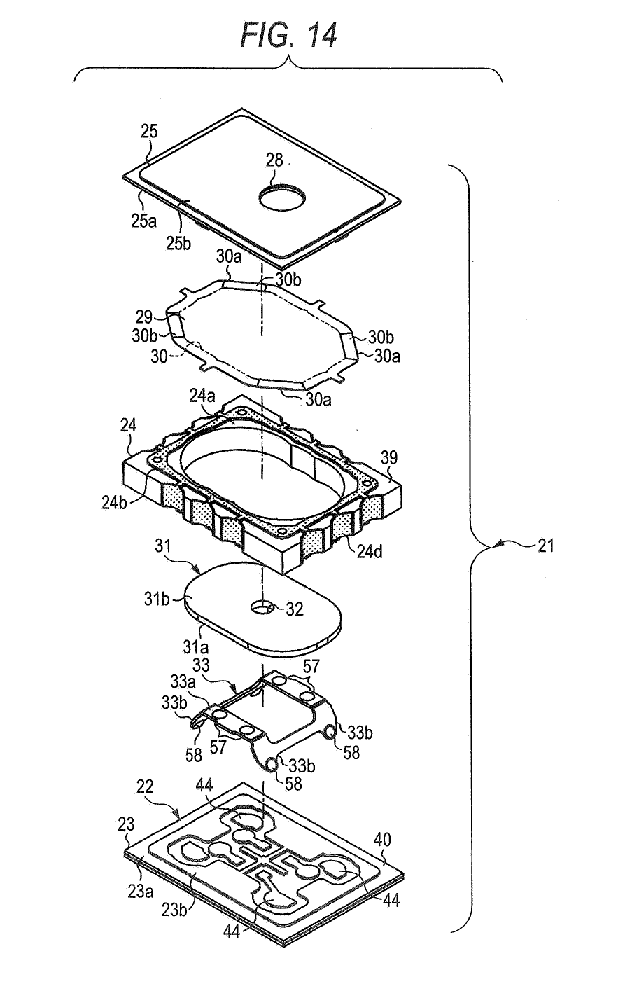

However, in the second embodiment, as shown in FIGS. 13 and 14, the exposed portion 40 is formed in the outer peripheral part including four corner portions on an upper surface of the substrate body 23a of the circuit substrate 23 and the exposed portion 39 is formed in the outer peripheral part including four corners on both upper and lower surfaces of the basic frame body 24a of the case basic frame 24, and the exposed portion 41 is formed in the outer peripheral part including four corners on a lower surface of the substrate body 25a of the top substrate 25. The circuit substrate 23 and the case basic frame 24 and the case basic frame 24 and the top substrate 25 are bonded between the exposed portions 40 and 39 and between the exposed portions 39 and 41 with the adhesive agents 42 and 43 made of the similar material.

Meanwhile, the spacer 30 made of stainless steel is formed in a cup shape and the vibrating membrane 29 is bonded and fixed onto an upper surface of the spacer 30. An assembly of the vibrating membrane 29 and the spacer 30 is laminated between the top substrate 25 and the case basic frame 24 and it is bonded and fixed therebetween. In the spacer 30, oblique side portions 30a are formed four corners and the exposed portion 39 of the case basic frame 24 and the exposed portion 41 of the top substrate 25 are bonded to each other in positions corresponding to the oblique side portions 30a with the adhesive agents 43 and 43 made of the similar material as described above.

Accordingly, even in the second embodiment, it is possible to acquire substantially the same advantage as the advantage disclosed in the first embodiment.

In the second embodiment, a gold deposition surface is formed on the lower surface of the vibrating membrane 29 and a folding-back portion 30b is formed on vibrating membrane 29 upwardly. As the result, the gold deposition surface of the vibrating membrane 29 in the folding-back portion 30b ensures the electric conduction between the vibrating membrane 29 and the conductive pattern 25c and the electric conduction between the spacer 30 and the electric conduction between the conductive pattern 24b of the case basic frame 24.

The present embodiment may be realized by the following modification.

The invention may be realized by an electret-type condenser microphone of a foil electret type in which a function of an electret is granted to the vibrating membrane 29 instead of the back plate 31.

Further, the invention may be realized by a charge pump-type condenser microphone in which a voltage is applied to the back plate 31 and the vibrating membrane 29 by a charge pump circuit.

Further, the invention may be realized by an MEMS (micro electro mechanical systems) microphone in which a microphone prepared by a semiconductor process is housed in the case.

### Third Embodiment

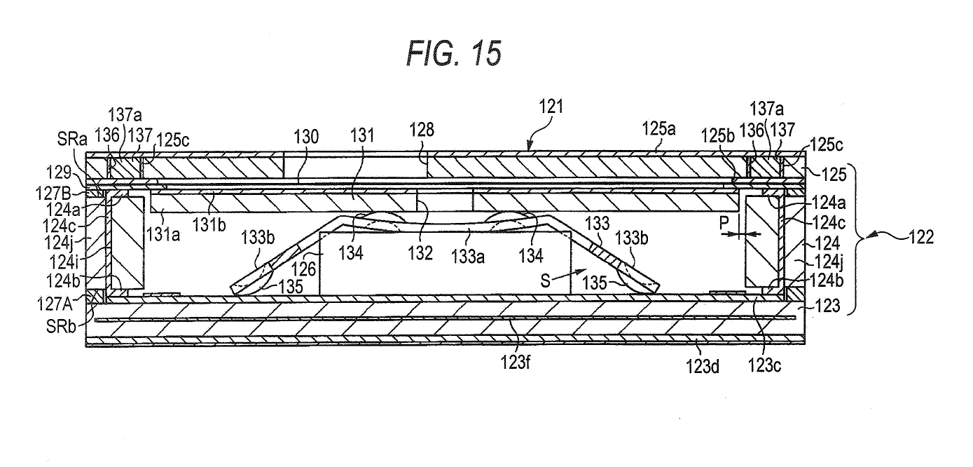

Hereinafter, a third embodiment according to the invention will be described focusing on parts other than those of the first and second embodiments with reference to FIGS. 15 to 19.

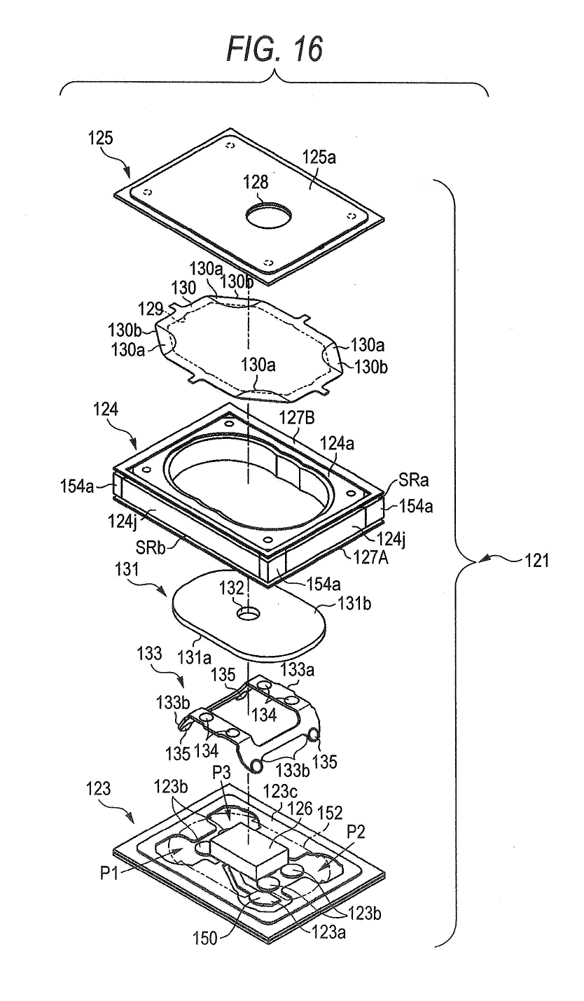

As shown in FIGS. 15 and 16, a case 122 of a condenser microphone 121 according to the embodiment has a structure in which a tabular circuit substrate 123 serving as a mounting substrate, a rectangular case basic frame 124 serving as a case substrate, and a tabular top substrate 125 serving as a top cover are laminated and they are integrally fixed by a bonding sheets 127A and 127B. The circuit substrate 123, the case basic frame 124, and the top substrate 125 are made of the electric insulating material such as the epoxy resin. In the embodiment, the member is made of a glass fabric-based epoxy resin and is not limited to the epoxy resin.

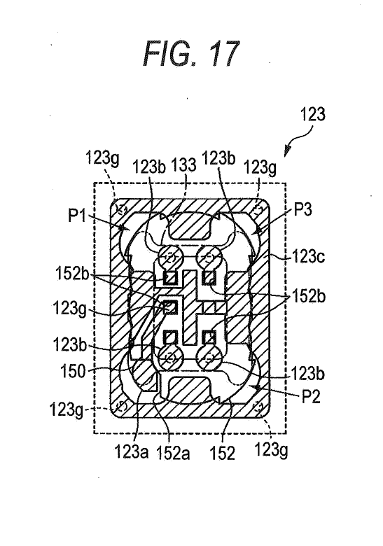

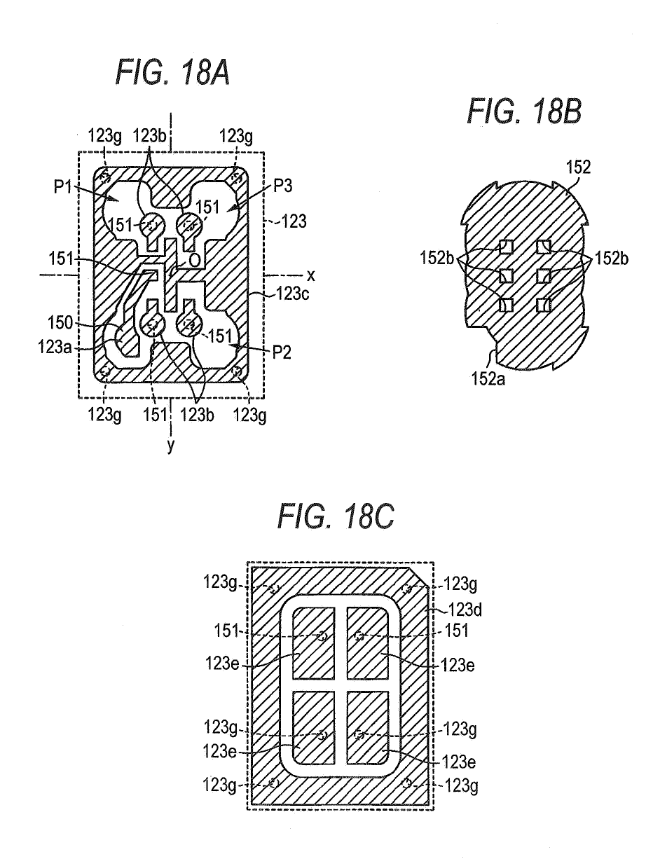

As shown in FIG. 18A, conductive patterns 123a, 123b, and 123c made of the copper foil as a conductive member are formed on an upper surface (alternatively, also referred to as a surface of the circuit substrate 123) of the circuit substrate 123. In the specification, the upper surface represents a surface facing an upside and the lower surface represents a surface facing a downside when the circuit substrate 123 is disposed in a lower side, the case basic frame 124 is disposed in a center, and the top substrate 125 is disposed in an upper side. The conductive patterns 123a, 123b, and 123c are shown by hatching for easy description in FIGS. 17 and 18A.

As shown in FIG. 18A, in the conductive pattern 123a, a first edge is positioned near one edge side in a longer direction and near one edge side in a shorter direction on the upper surface of the circuit substrate 123 and a second edge 151 is extends toward a center side on the upper surface of the circuit substrate 123. The first edge of the conductive pattern 123a is formed of a conductive section 150.

Here, on the upper surface of the circuit substrate 123, an axis in a shorter direction represents an x axis and an axis in a longer direction represents a y axis, which are orthogonal to each other on a central axis o (see FIG. 18A) penetrating in a thickness direction of the circuit substrate 123.

On the upper surface of the circuit substrate 123, a line symmetric area P1 of the conductive section 150 in which the x axis serves as a symmetric axis, a line symmetric area P2 of the conductive section 150 in which the y axis serves as the symmetric axis, and a point symmetric area P3 of the conductive section 150 in which the central axis o serves as a central point are included in an area (hereinafter, referred to as a nonconductive pattern area) in which the conductive pattern is not provided. The nonconductive pattern area represents an area surrounded by the conductive patterns 123c and excluding the conductive patterns 123a and 123b on the surface of the circuit substrate 123. The plurality of conductive patterns 123b (four conductive patterns in the embodiment) is provided in the embodiment.

The conductive pattern 123c as an earth conductive pattern is formed in a cup shape so as to face a cup shape of the case basic frame 124. The conductive patterns 123a and 123b serves as power input or a value signal fetching as a conductive pattern for component connection.

As shown in FIGS. 17 and 18B, a surface including the areas P1 to P3 is covered with a resist 152 on a part of the upper surface of the conductive patterns 123a to 123c and in the nonconductive pattern area. The resist 152 is shown by hatching in FIG. 18B for easy description.

The resist 152 as an insulating member is made of the epoxy resin, but it is not limited to the material and all insulating synthetic resins can be used. The resist 152 is formed in an even film thickness throughout an entirety thereof (i.e. an entirety including the areas P1 to P3) and has the same thickness as the conductive section 150. In other words, the resist 152 positioned in the areas P1 to P3 has the same height (i.e. thickness) as the conductive sections 150 on the basis of the upper surface of the circuit substrate 123. The thicknesses of the conductive section 150 and the resist 152 are generally set approximately to 20 μm to 40 μm. In the embodiment, the thicknesses of the conductive section 150 and the resist 152 are set to 30 μm. In the resist 152, a notch 152a is formed around the conductive section 150 and the conductive section 150 is exposed. In the resist 152, windows 152b are provided in a second edge 151 of the conductive pattern 123a, edges of the conductive patterns 123b, and a portion corresponding to a part of the conductive pattern 123c and thus, the portions are exposed through the window 152b.

A cup-shaped peripheral portion of the conductive pattern 123c is formed of an exposed portion which is not covered with the resist 152 and faces the case basic frame 124.

As shown in FIG. 18C, a plurality of conductive patterns 123d and 123e (only one conductive pattern 123d is shown in FIG. 15) made of the copper foil is formed on the lower surface (alternatively, also referred to as a back surface) of the circuit substrate 123. In FIG. 18C, the conductive patterns 123d and 123e are shown by hatching for easy description.

A plurality of through-holes 123g is provided in the circuit substrate 123 and conductive layers not shown is formed in inner peripheries of the same through-holes 123g. The conductive pattern 123c is connected to the conductive pattern 123d on the lower surface of the circuit substrate 123 via the conductive layers of several through-holes 123g out of the plurality of the same through-holes. A part of the conductive pattern 123d serves as an earth terminal.

The conductive patterns 123a and 123b are connected to the conductive pattern 123e connected to a signal output terminal (not shown) or a power input terminal (not shown) on the lower surface of the circuit substrate 123 via the conductive layers of the other through-holes out of the plurality of the same through-holes.

As shown in FIG. 15 a interlayer 123f made of the copper foil is provided in the circuit substrate 123 and thus, the interlayer 123f is electrically connected to the through-hole 123g electrically connecting the conductive patterns 123c and the conductive pattern 123d.

An electric-field transistor 126 constituting an impedance converting element, as a field-effect component provided in the case 122, is mounted on the circuit substrate 123. The field-effect transistor 126 is electrically connected to a second edge 151 of the conductive pattern 123a and ends of several conductive patterns 123b out of the plurality of conductive patterns 123b.

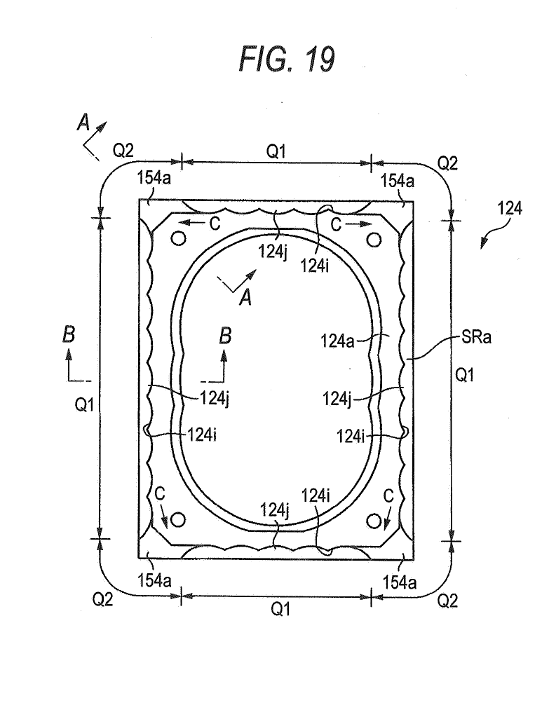

The case basic frame 124 has opening portions on both upper and lower ends thereof and the conductive patterns 124a, 124b, and 124c made of the copper foil, which are arranged in series are formed on the both upper and lower end surfaces and an external surface of a side wall as shown in FIG. 15. As shown in FIGS. 16 and 19, the conductive patterns 124a and 124b are formed in a perimeter shape in both peripheral edges of both upper and lower opening portions of the case basic frame 124. In FIGS. 16 and 19, the only conductive pattern 124a is shown and the conductive pattern 124b is also formed in the same shape as the conductive pattern 124a shown in FIGS. 16 and 19.

The conductive pattern 124c is formed on the external surface of the side wall of the case basic frame 124 by applying a conductive paste including a metal such as a copper is applied onto an inner surface of a concave portion 124i provided in a part other than an external surface of four corner parts C of the same case basic frame 124 or by performing metal foil plating such as copper plating on the inner surface of the concave 124i, whereby the conductive pattern 124c electrically connects the conductive patterns 124a and 124b (see FIG. 15). The conductive pattern 124c corresponds to a metallic layer.

A metal plating layer may be formed on the conductive patterns 124a and 124b in a final step of forming the conductive pattern or the through-hole in the case basic frame 124. Accordingly, since the conductive patterns 124a and 124b protrude to the surface from a through-hole filled with the resin, a clearance into which a bonding sheet 127A are input is enlarged, thereby improving the bonding strength. When a metal plating layer is formed on the conductive patterns 124a and 124b, thicknesses of the conductive patterns 124a and 124b are preferably approximately in the range of 25 μm to 40 μm.

In FIG. 19, Q1 represents a range of the conductive pattern 124c provided in the concave portion 124i of the case basic frame 124. The conductive pattern 124c is provided in the concave portion 124i provided on the external surface of the side wall of the case basic frame 124, thereby producing an electromagnetic shield. A portion in which the conductive pattern 124c is provided corresponds to an electromagnetic shield section.

As shown in FIG. 19, on the external surface of the case basic frame 124, portions 154a in which the conductive pattern 124c is not provided are provided in the corner portions C of the case basic frame 124. The portions 154a in which the conductive pattern 124c is not provided constitute a part of a connecting section 154 described in a manufacturing method described below and external surfaces of the same portions 154a corresponds to a nonelectromagnetic shield section. In FIG. 19, Q2 represents a range of the nonelectromagnetic shield section. As shown in FIG. 15, the conductive pattern 124b on the lower surface is connected to the conductive pattern 123d on the lower surface of the circuit substrate 123 via the conductive pattern 123c on the circuit substrate 123.

A filling portion 124j filled with an insulating synthetic resin such as the epoxy resin is formed in the concave portion 124i (see FIG. 15). The insulating synthetic resin such as the epoxy resin corresponds to a filler and a resin filler.

In the case basic frame 124, substantially rectangular cup-shaped bonding areas SRa and SRb are formed of both upper and lower surfaces of the portions 154a in which both upper and lower surfaces of the filling section 124j and the conductive pattern 124 are not provided. In FIG. 19, the only bonding portion SRa provided on the upper surface of the case basic frame 124 is shown. The bonding areas are not limited to a rectangular cup shape, but the bonding areas may have other shapes. Consequently, the bonding areas may have shapes similar to the cup shape of the case basic frame 124.

As shown in FIGS. 15 and 16, a peripheral edge of an opening portion in a lower part of the case basic frame 124, i.e., the bonding area SRb is integrally bonded and fixed to the circuit substrate 123 by the bonding sheet 127A as a rectangular perimeter-shaped adhesive agent disposed outside the conductive pattern 123c. The bonding sheet 127A is made of the same material as the resin filler used in the filling section 124j. Electric components of the field-effect transistor 126 on the circuit substrate 123 is housed and disposed in the case basic frame 124.

The material of the bonding sheet 127A may have the same configuration as a resin material part used in a substrate of the case basic frame 124 of the bonding sheet 127A. Accordingly, assuming that the bonding sheet 127A, the circuit substrate 123, and the top substrate 125 have the same material as the resin material part, they can obtain the same advantage as the resin material part.

As shown in FIG. 15, conductive patterns 125a and 125b made of the copper foil are formed on both upper and lower surfaces of the top substrate 125. A sound hole 128 for taking in sound from an outside is formed in the top substrate 125.

As shown in FIGS. 15 and 16, a peripheral edge of an opening portion in an upper part of the case basic frame 124, i.e., the bonding area SRa is integrally bonded and fixed to the top substrate 125 by the bonding sheet 127B as a rectangular perimeter-shaped adhesive agent disposed outside the conductive pattern 124a. The bonding sheet 127B is made of the same material as the resin filler used in the filling section 124j. The peripheral edge of the opening portion in the upper part of the case basic frame 124 is integrally connected to the top substrate 125 via a spacer 129 and a vibrating membrane 130.

As shown in FIGS. 15 and 16, the perimeter-shaped spacer 129 formed of an insulating film is interposed and fixed between the case basic frame 124 and the top substrate 125. The spacer 129 is bonded to the conductive pattern 124a by the conductive adhesive agent. The vibrating membrane 130 formed of a synthetic resin thin film having insulation property such as a PPS (polyphenylene sulfide) film is tightly provided by bonding on an upper surface of the spacer 129 and a conductive layer 130a formed by gold deposition is formed on a lower surface of the vibrating membrane 130.

Through-holes not shown are provided in the vibrating membrane 130 and the spacer 129 and the conductive layer 130a can be conducted to the conductive pattern 124a via the conductive paste filled in the same through-holes and a conductive adhesive agent (not shown) between the spacer 129 and the case basic frame 124 (exactly, the spacer 129 and the conductive pattern 124a).

As shown in FIG. 15, a plurality of through-holes 136 is formed in the top substrate 125 and a conductive pattern 125c arranged in series with the conductive patterns 125a and 125b is provided on inner peripheral surfaces of the through holes 136. A conductive adhesive agent 137a is filled in the through-holes 136 and a conductive section 137 is formed of the conductive adhesive agent 137a and the conductive pattern 125c. The conductive section 137 is electrically connected to the conductive layer 130a of a folding-back portion 130b (see FIG. 15) formed by folding back the lower surface of the vibrating membrane 130. Even though the conductive adhesive agent 137a is not filed in the through-holes 136, the conductive pattern 125c may be formed and when the conductive pattern 125c is not formed in the through-holes 136, the conductive adhesive agent 137a may be filled therein. Both the conductive pattern 125c and the conductive adhesive agent 137a are formed, thereby improving conductivity and shield property.

A conductive path from the conductive patterns 125a and 125b of the top substrate 125 reaching the earth terminal on the circuit substrate 123 is formed through the conductive section 137, the conductive layer 130a, the conductive pastes of the through-holes not shown provided in the vibrating membrane 130, the conductive adhesive agent between the spacer 129 and the conductive pattern 124a, and the conductive patterns 124a to 124c on the case basic frame 124 is formed.

In the case basic frame 124, the back plate 131 as a polar plate is opposed to the lower surface of the vibrating membrane 130 with the spacer 129 interposed therebetween. In the back plate 131, a film 131b such as PTFE (polytetrafluorethylene) is bonded and fixed to an upper surface of a back plate body 131a formed of stainless steel. The polarization treatment is performed on the film 131b by the corona discharge and the film 131b constitutes the electret layer by the polarization treatment. In the embodiment, since the back plate 131 constitutes the back electrode, the condenser microphone of the embodiment is the back electret type.

The back plate 131 is formed in a substantially elliptic shape in a plan view, which has an outer peripheral shape smaller than an inner peripheral shape of the case basic frame 124. A clearance P is formed between the inner and outer peripheral surfaces. A through-hole 132 for allowing the air transfer by vibration of the vibrating membrane 130 is formed in a central part of the back plate 131. The back plate 131 is formed by punching a stainless steel plate material to which the film 131b is bonded from the film 131b, i.e., an upper side of FIG. 16 to a lower side by a punching blade (not shown).

As shown in FIGS. 15 and 16, in the case basic frame 124, a holding member 133 formed of a plate spring material is interposed between the back plate 131 and the circuit substrate 123 in a compression state. The back plate 131 is compressed in a direction abutting lower surfaces of the spacers 129 from an opposite side of the vibrating membrane 130 by a resilient force of the holding member 133. Accordingly, a predetermined clearance is held between the vibrating membrane 130 and the back plate 131 and a condenser section having a predetermined capacity is formed therebetween.

The holding member 133 is formed by punching and molding a plate material formed by gold-plating both front and back surfaces of the stainless steel plate. The holding member 133 has a substantially perimeter-shaped frame portion 133a and four legs portions 133b protruding toward both lower sides on four corners of the frame portion 133a. Accordingly, a space S is formed between the leg portions 133b in a lower side of the frame portion 133a. In the embodiment, as shown in FIG. 15, the field-effect transistor 126 on the circuit substrate 123 is disposed between a pair of leg portions 133b in the space S.

Four sphere-shaped contact portions 134 as a protruding portion, which abut a lower surface of the back plate 131 protrude on an upper surface of the frame portion 133a of the holding member 133 and four sphere-shaped contact portions 135 as the protruding portion protrude on a front lower surface of each of the leg portions 133b.

One leg portion 133b selected from a plurality of leg portions 133b is contacted to the conductive section 150 via the contact portion 135 and the other leg portions 133b is contacted to the upper surface of the resist 152 positioned in the areas P1 to P3 included in the nonconductive pattern area via the contact portion 135 on the upper surface of the circuit substrate 123.

However, in the condenser microphone 121, when a sound wave from a sound source reaches the vibrating membrane 130 through the sound hole 128 of the top substrate 125, the vibrating membrane 130 vibrates depending on a frequency, an amplitude, and a waveform of the sound. A gap between the vibrating membrane 130 and the back plate 131 is varied from a set value with vibration of the vibrating membrane 130 and thus, an impedance of the condenser is varied. The variation of the impedance is converted into a voltage signal by the impedance converting element.

The condenser microphone according to the embodiment has the bonding areas SRa and SRb on front and back surfaces of the case basic frame 124 and the top substrate 125 and the circuit substrate 123 mounted with the electric components are bonded to all bonding areas SRa and SRb on the front and back surfaces of the case basic frame 124 with the adhesive agent without using the metallic layer. As the result, the bonding performances between an insulating substrate Kc (the core material) of the case basic frame 124 and the circuit substrate 123 and between the insulating substrate Kc (the core material) of the case basic frame 124 and the top substrate 125 are improved.

Since the both upper and lower surfaces of the filling section 124j positioned in the bonding areas SRa and SRb, the top substrate 125, the circuit substrate 123, and the filling section 124j are made of the same material as the adhesive agent, the bonding performance is not damaged.

The present embodiment may be realized by the following modification.

In the embodiment, the back plate body 131a is formed of the stainless steel, but it may be formed of a brass plate or a titanium plate.

Further, the invention may be realized in a method of manufacturing the foil electret-type condenser microphone in which the vibrating membrane 130 is formed of an electret polymer film.

Further, the invention may be realized in a method of manufacturing a charge pump-type condenser microphone having a booster circuit. When the microphone is configured as above, the vibrating membrane 130 is changed into the electret layer and electrodes opposed to each other are provided in the vibrating membrane 130 and the back plate 131.

In the embodiment, an electret condenser microphone of a back electret type is described, but the invention may be applied to an electret condenser microphone of a front electret type.

The impedance converting element mounted on the circuit substrate 123 of the embodiment is exemplified. As long as it is a known impedance converting element, any impedance converting element in which variation of an electrostatic capacitance can be detected employs any one of analog and digital operating modes may be used.

What is claimed is:

1. A microphone case comprising:
a plastic basic frame including a space for housing an electro-acoustic transducing unit;
a plastic substrate for closing an opening of the space, the plastic substrate being bonded to the basic frame;
conductive layers provided on the bonding surfaces of the basic frame and the substrate respectively, the conductive layers being electrically connected to each other; and
exposed portions where the resin surfaces of the basic frame and the substrate are exposed, the exposed portions being provided on the bonding surfaces, wherein
the basic frame and the substrate are bonded to each other in the exposed portions.

2. The microphone case according to claim 1, wherein:
the basic frame and the substrate are made of similar materials; and
the basic frame and the substrate are bonded to each other with a bonding member made of the similar materials.

3. The microphone case according to claim 2, wherein
the bonding member is a heat-resistant bonding sheet.

4. The microphone case according to claim 2, wherein
the bonding member is a curable contractile bonding member.

5. The microphone case according to claim 3, wherein
the plastic substrate includes: a first substrate, which is mounted with an electric component and closes one end of the opening of the basic frame; and a second substrate, which includes a sound hole and closes the other end of the opening of the basic frame.

6. The microphone case according to claim 5, wherein
the electric component is fixed to the substrate by a fluxless fixing method.

7. The microphone case according to claim 1, comprising:
a case substrate including a metallic layer;
bonding areas provided on front and back surfaces of the case substrate;
a top substrate; and
a circuit substrate mounted with electric components, wherein
the top substrate and the circuit substrate are bonded and fixed to the bonding areas respectively without using the metallic layer with an adhesive agent.
